(19) United States
(12) Patent Application Publication
(10) Pub. No.: US 2022/0371449 A1
(43) Pub. Date: Nov. 24, 2022

(54) Renewable Power Generation System for Vehicles

(71) Applicants: Dennis Woodward, Las Vegas, NV (US); Tyler Woodward, Sandy Hook, VA (US)

(72) Inventors: Dennis Woodward, Las Vegas, NV (US); Tyler Woodward, Sandy Hook, VA (US)

(21) Appl. No.: 17/671,871

(22) Filed: Feb. 15, 2022

Related U.S. Application Data
(60) Provisional application No. 63/189,891, filed on May 18, 2021.

(51) Int. Cl. B60L 8/00; B60L 50/61; B60L 58/12; B60K 8/00; F03D 9/00; F03D 9/32; F03D 9/25; F03D 9/11; H02S 10/12

(52) U.S. Cl. CPC B60L 8/006; B60L 50/61; B60L 58/12; B60L 8/003; B60K 8/00; F03D 9/007; F03D 9/32; F03D 9/25; F03D 9/11; H02S 10/12; F05B 2220/708; F05B 2220/706; F05B 2240/941

(57) ABSTRACT

The present invention relates to an electric power generating system for vehicles. The system includes at least one wind turbine positioned to capture incoming air which is coupled to a wind generator for converting into electric power. The system has solar panels installed on the exterior surface of the vehicle such as trailer of a semi-truck for absorbing solar energy and converting into electric power. The electric power produced by the wind generator and the solar panels is stored in a battery pack for providing electric power to the electric battery of the vehicle. An emergency generator provides electric power to the vehicle when the power of both the electric battery and the battery pack is insufficient. The system slows down the depletion of battery charge, thus enabling the vehicle to stay on the road for a longer duration and improves overall charging experiences for the electric vehicle.

### CROSS-REFERENCE TO RELATED APPLICATION

The present application claims priority to, and the benefit of, U.S. Provisional Application No. 63/189,891, which was filed on May 18, 2021, and is incorporated herein by reference in its entirety.

### FIELD OF THE INVENTION

The present invention relates generally to the field of electric vehicles or EVs. More specifically, the present invention relates to a novel renewable and environment friendly power generation system used for recharging an electric battery of a vehicle so that frequent stops for recharging a battery of the vehicle are reduced. The system includes a wind turbine generator system for capturing wind and producing electric power and features a full set of solar panels for supplying electric power to the vehicle's electrical system. A supplemental generator is used during emergency needs of electrical power. A battery pack stores the electric power and provides energy to the electric battery and system of the vehicle. Accordingly, the present disclosure makes specific reference thereto. Nonetheless, it is to be appreciated that aspects of the present invention are also equally applicable to other like applications, devices and methods of manufacture.

### BACKGROUND

By way of background, diesel fuel is used for running standard over the road vehicles such as semi-truck vehicles. The use of petroleum diesel fuel is not only costly but is also harmful for the environment and emits a number of greenhouse gases (GHG). Diesel fuel is refined from fossil based resources such as crude oil and produces many harmful emissions when it is burned, such as part of an internal combustion engine. The diesel-fueled vehicles are a major source of harmful pollutants, such as GHG and particulate matter. Pollution from diesel exhaust includes soot or particulate matter (PM), oxides of nitrogen (NOx) which contributes to the production of ground-level ozone (smog) and acid rain, hydrocarbons (HC) and many more other pollutants.

Newer electric semi-trucks and other vehicles have an electric battery for providing power to the vehicle. However, the energy provided by the battery is limited, and keeping the battery charged for a long period of time can be challenging. In contrast to diesel vehicles, which often have large capacity fuel tanks, electric vehicle drivers need to frequently stop at electric charging stations to recharge limited-range electric vehicle batteries in a time consuming manner. People desire a way that can enable charging of their vehicle's battery in an environmental friendly manner, thereby enabling the truck or vehicle to stay on the road for a longer duration.

Therefore, there exists a need in the art for a power generation system for vehicles such as semi-trucks that can slow the depletion of the battery charge, thus enabling the truck to stay on the road for a longer duration. There is also a need in the art for a vehicle power generation system that does not emit pollution in amounts compared with conventional diesel vehicles and is environment friendly. Additionally, there is a need in the art for a power system for vehicles that can charge the existing electric battery of the vehicles. Moreover, there is a need in the art for a power generation mechanism that reduces frequent stops for recharging a battery or refilling fuel tanks during a trip. Further, there is a need in the art for a power generation mechanism that uses renewable and clean energy and is cost effective. Finally, there is a need in the art for a power generation mechanism that improves the overall charging experiences for the electric semi-trucks and supplements the power provided by the existing electrical battery.

The subject matter disclosed and claimed herein, in one embodiment thereof, comprises a power generating system for an electric vehicle such as a semi-truck. The system features a full set of solar panels installed on the semi-trailer to absorb solar energy and convert it into electricity for supplying power to the truck's electrical system to provide motive power to the vehicle. The system also features wind turbine mounted on the underside of the trailer and/or to the front of the truck for harnessing the flow of the wind while the truck and trailer is traveling and converts the renewable energy into electrical energy. A 10-50 KVA supplemental generator is mounted to the face or under the underside of the trailer for use during an emergency need of electrical power and a trailer mounted battery pack is connected to the truck's electrical system for storing electric power produced by the turbines and solar panels.

In this manner, the renewable and environment friendly power generation system of the present invention accomplishes all of the forgoing objectives and provides users with a system that uses solar panels and wind powered turbine system to supply power to the truck's electrical system in order to generate motive energy for the vehicle. The system has a backup generator for use during emergency requirements for electrical power which will utilize quick charge battery technology. The wind turbines and solar energy together help reduce vehicle stops to recharge the vehicle and effectively improve travel times and charging time.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a power generating system for an electric semi-truck, buses, trains, boats or other vehicle. The system is designed to produce electric power from renewable and environment friendly sources to provide energy to an electric battery of the vehicle. The system further includes a plurality of wind turbines, including a turbine on the underside of the trailer, wherein each turbine has a plurality of blades for capturing wind flowing in from the front of the vehicle, top of the vehicle and between the vehicle and the trailer where the vehicle is pulling a trailer. A turbine generator is configured to rotate or spin using the incoming wind by the turbines for converting the wind power into electric power. The system further has solar panels installed on the exterior surface of the trailer for absorbing solar power and converting the solar energy into electric power. Furthermore, the electric power produced by the turbine generator and the solar panels is stored in a battery pack that is configured to provide electric power to the vehicle's battery when the power of vehicle's battery is less than a predetermined threshold.

In yet another embodiment, the power generating system has an emergency or supplemental generator mounted to the face of the trailer and/or the underside of the trailer that is configured to provide power to the vehicle's battery when the power of the battery pack is less than an established threshold.

In yet another embodiment, the solar panels are installed on the top surface and side surfaces of the trailer or top of the vehicle.

In yet another embodiment, a power generation system is disclosed for providing electric power to an existing electric battery and electrical system of a vehicle such as a semi-truck, delivery van or other vehicle. The system includes a first wind turbine mounted on front top of a trailer pulled by the vehicle, a second turbine is mounted in front of the truck, the first wind turbine and the second wind turbine have blades for capturing the incoming wind. A wind turbine generator is positioned on the underside of the trailer base for converting the captured wind to electric power. The solar panels are disposed on one or more exterior surfaces, e.g. top, sides, back and front of the trailer for producing electric power from solar energy. A battery pack is disposed below the trailer for storing the electric power produced by the wind turbine generator and the solar panels. A plug adapter connects the battery pack with an existing electric battery of the vehicle. The battery pack is configured to transmit electric power to the existing electric battery of the vehicle.

In yet another embodiment, the first wind turbine mounted on the front top of a trailer has a louver system disposed on top of the truck for providing a channel for wind to enter into the first wind turbine. The louver system is activated when the driver of the vehicle releases pressure on the pedal, thereby not reducing the efficiency of the vehicle during acceleration or deceleration. The louver system may also be located on the skirts of the trailer, wherein said louver system controls the turbine that may be located on the underside of the trailer.

The turbine or turbines of the present invention serve to generate electricity to the system while simultaneously acting as an air brake. By way of example, if a truck is on an extended downgrade the air being pushed to the turbines introduces drag onto the vehicle while spinning the generators to create electrical power. In this manner, when the driver of the truck releases the gas pedal, the louver system opens.

In yet another embodiment, the range of the vehicle is increased from 300 miles to 800 miles using the system of the present invention.

In yet another embodiment of the present invention, a method is disclosed for providing clean energy to an electric vehicle, thereby reducing frequent stops for recharging the vehicle's battery. The method includes the step of recharging a battery pack which is installed at the bottom of the vehicle using electric power produced from one or both of the solar energy and wind energy systems. The solar energy is converted into electric power by solar panels that are installed on exterior surface of the vehicle. The wind energy is converted into electric power by the wind turbine generation system installed on the vehicle. The converted electrical power is stored in the battery pack, wherein the battery pack will continuously receive electrical power from the solar panels and/or wind turbines, unless the battery pack is fully charged. In addition, the backup generator may further be activated based on a voltage threshold of the entire electrical system of the invention and/or truck.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of one potential embodiment of a renewable and environment friendly power generator system of the present invention designed for a semi-truck in accordance with the disclosed architecture;

FIG. 2 illustrates a perspective view of a semi-truck with one potential embodiment of an installed power generator system of the present invention in accordance with the disclosed architecture;

FIG. 3 illustrates a close-up view of the barrier protecting the wind turbine generator and the internal battery pack used in one potential embodiment of the power generation system of the present invention in accordance with the disclosed architecture;

FIG. 4 illustrates a flow diagram showing one potential process of harnessing wind energy for producing electric power using the semi-truck power generation system of the present invention in accordance with the disclosed architecture;

FIG. 5 illustrates a flow diagram showing the potential steps performed by one potential embodiment of the renewable power generation system of the present invention for providing electric power to the vehicle's battery and or electrical system in accordance with the disclosed architecture; and

FIG. 6 illustrates a close view showing the connection of the backup generator and electrical battery of the vehicle along with the adaptor or plug for connecting the battery pack of the power generation system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a need in the art for a power generation system for vehicles such as semi-trucks, delivery vehicles, buses, and other over the road transportation that can slow the depletion of the battery charge, thus enabling the truck or vehicle to stay on the road for a longer duration. There is also a need in the art for a vehicle power generation system that reduces the amount of pollution when compared to conventional vehicles and other EV being charged from a carbon-based grid and is environment friendly. Additionally, there is a need in the art for a power generation system for vehicles that can recharge the existing electric battery contained on the vehicles. Moreover, there is a need in the art for a power generation mechanism that reduces the need for frequent stops for recharging the battery or refilling fuel tanks during a trip in the event it is a hybrid vehicle having both batteries and an internal combustion engine. Further, there is a need in the art for a power generation mechanism that uses clean energy and is cost effective to operate. Finally, there is a need in the art for a power generation mechanism that improves the overall charging experiences for the electric semi-truck or other vehicles and supplement the power provided by existing electrical battery.

The present invention, in one exemplary embodiment, is a novel power generating system for an electric semi-truck or other over the road transportation vehicle, such as delivery vans and buses. The system produces electric power from renewable and environmentally friendly sources, such as sun and wind, to provide energy to the electric battery of the semi-truck. The system has a plurality of wind turbines, with each turbine having a plurality of blades for capturing wind flowing in front of the semi-truck, top of the semi-truck and between the semi-truck and the trailer and beneath the vehicle or trailer where the vehicle is pulling a trailer. A turbine generator is configured to rotate or spin using the captured wind by the turbines for converting wind power into electric power. The system further has solar panels installed on exterior surface of the trailer or vehicle for absorbing solar power and convert the energy into electric power. Furthermore, the electric power produced by the turbine generator and the solar panels are stored in a battery pack that is configured to provide electric power to the truck's battery when the power of the truck's battery is not at full battery.

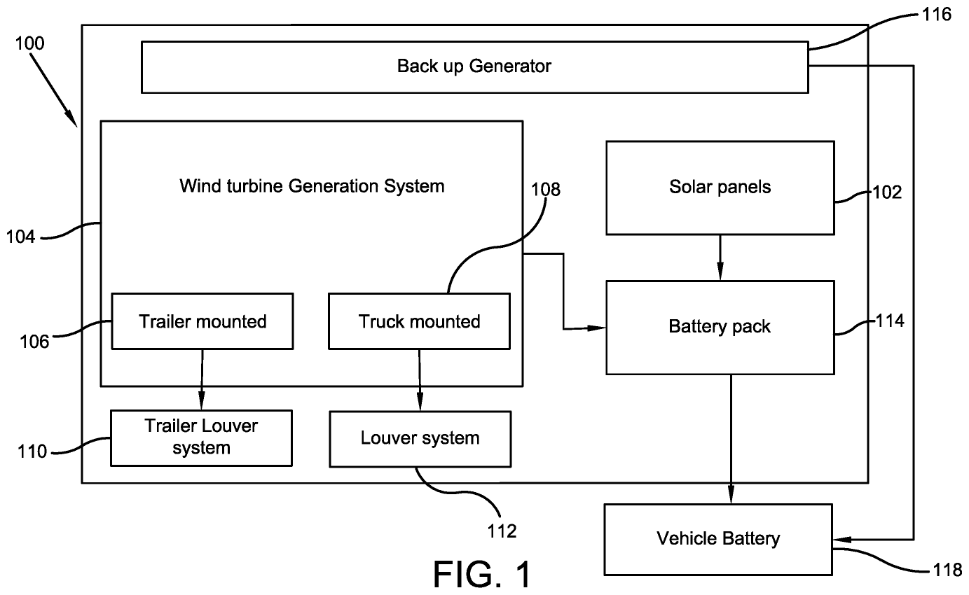

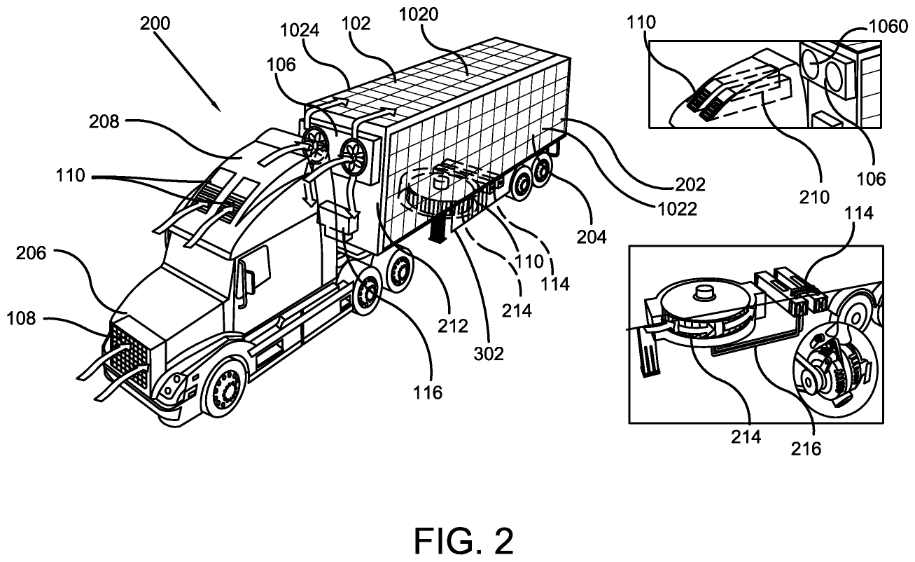

Referring initially to the drawings, FIG. 1 illustrates a block diagram view of renewable and environment friendly power generator system 100 of the present invention designed for a semi-truck, over the road vehicle, transportation vehicles such as buses and other vehicles in accordance with the disclosed specification. The power generator system 100 of the present invention is designed for electric semi-trucks and over the road vehicles but can be used for other electric vehicles. The system 100 provides users with a renewable and environmentally conscious power generation system for electric semi-truck vehicles that slows the depletion of the charge contained in the battery, thus enabling the truck or vehicle to stay on the road for a longer duration. The system 100 includes a full set of photovoltaic solar panels 102. The solar panels 102 are weatherproof and are configured to absorb solar energy and convert the captured energy into electrical energy. The solar panels 102 are installed on the exterior surface of the semi-trailer as best shown in FIG. 2.

The system 100 includes a wind turbine generator system 104 for converting wind energy into electrical energy and for providing the converted electrical energy to the electric battery to provide motive power for the truck or vehicle. The wind turbine generator system 104 has one or more trailer or vehicle mounted wind turbine-generators 106 positioned on the front of the trailer and bottom of the trailer as best shown in FIG. 2. If no trailer is provided solar panels can be provided on the roof of the vehicle or side walls such as with a bus which provides a significant amount of surface area to position the solar panels. Additionally, the system 100 has a truck or vehicle mounted turbine 108 that is used for harnessing the flow of incoming air across the truck. The trailer mounted wind turbine-generators 106 have their own trailer louver system 110 that allows the incoming air to pass to the vanes of the wind turbines 106. The trailer louver system 110 provides the necessary wind to the vanes enabling the trailer mounted turbines 106 to work efficiently to produce electricity and provide a motive force for the vehicle. Similarly, the louver system 112 is used in conjunction with the truck mounted turbine 108 for using wind for producing electric power.

The solar panels 102 provide the electric power to a battery pack 114 of the power generation system 100. The battery pack 114 is used for storing the electric power produced by the solar panels 102. The solar panels 102 can be connected to the battery pack 114 through a conventionally wired circuit. The wind turbine generation system 104 provides the generated electric power to the battery pack 114. The wind turbines 106, 108 are connected to the battery pack 114 through a separate wired circuit.

The use of the internal battery pack 114 is that it stores the electric power generated by the system 100 and transfers the stored electric power to the vehicle battery 118. It should be noted that the vehicle battery 118 is not a component of the system 100 of the present invention and is connected to the battery pack 114 through a plug or other adaptor (not shown).

The system 100 has a backup or emergency generator 116 that is used for providing electric power to the truck's electric battery 118. The emergency generator 116 is used when both the vehicle battery 118 and internal battery 114 do not have sufficient electric power for running or operating the truck. This ensures that the vehicle or truck is on the road for longer periods of time without having to stop for recharging the vehicle battery 118.

FIG. 2 illustrates a perspective view of a semi-truck 200 with an installed power generator system 100 of the present invention in accordance with the disclosed system. For use of the system 100, a full set of photovoltaic solar panels 102 are installed on the exterior surface 204 of the top surface 1020, and side surfaces 1022, 1024 of the semi-trailer 202. The solar panels 102 are configured to absorb solar energy and convert the solar energy into electrical energy. The converted electrical energy is delivered to the system's electrical battery 114. Solar panels 102 are almost flexible, thin, lightweight and capable of being affixed to the curves of the semi-trailer 202.

It should be noted that a standard 53′ semi-trailer can accommodate an approximately 1,200-Square Feet (SF) solar panel field. Further, on average, the solar panels 102 produce 12-15 watts per square foot of solar panel area. So, the solar panels 102 on a sunny day, at 15 watts/SF, can generate about 18 KW of power for delivering to the truck's electric battery. The energy supplied to the truck's electric battery from the solar panels is produced from renewable sources of energy in an environment friendly manner.

As stated earlier, the wind turbine generator system 104 includes a trailer mounted wind turbine-generator 106 and a wind turbine-generator 108 positioned on the front 206 of the truck 200. The trailer mounted wind turbine-generator 106 has its own louver system 110 positioned on the spoiler 208 on top of the truck 200. The truck mounted wind turbine-generator 108 is used for harnessing the flow of wind across the truck. The louver system 110 is open when the truck driver releases pressure or is “off the pedal” allowing air to pass through the passage 210 to the trailer mounted wind turbine-generator 106. When the air passes through the turbine-generators 106, the vanes 1060 spin to convert wind energy into electrical energy and the converted electrical energy is supplied to the internal battery 114 of the system. In this manner, a drag force is introduced on the trailer such that the wind turbine-generator 106 functions as an air brake for the truck 200 (i.e., assisting in the braking of the truck 200) while also generating electricity.

The battery pack 114 is positioned at the bottom of the trailer 202 that stores electric power produced by the solar panels 102 and the wind turbine generator system 104. The battery pack 114 is configured to provide power to the battery system of the truck as described in FIG. 1 and is connected to the truck's battery system using a plug or other adapter and in one embodiment the plug adapter is positioned on the face of the trailer.

The 10-50 KVA (Kilo Volt-Ampere) back up or emergency generator 116 is used for providing energy during an emergency. This is especially useful in areas where the solar energy and/or wind energy is not present due to weather or other environmental conditions and in remote areas where the charging stations are not readily available. The backup generator is preferably mounted to the face 212 of the trailer or alternatively under the underside of the trailer.

The lower wind turbine-generator 214 is positioned at the bottom of the trailer 202 and has a louver 110 built into the trailer skirt 302. The generator 214 is used for converting the incoming wind energy received and driven by louvers 110 through the trailer skirt 302 to electricity and the converted electric power is stored in the battery pack 114. The generator 214 and the battery pack 114 are connected to each other through a wired circuit 216.

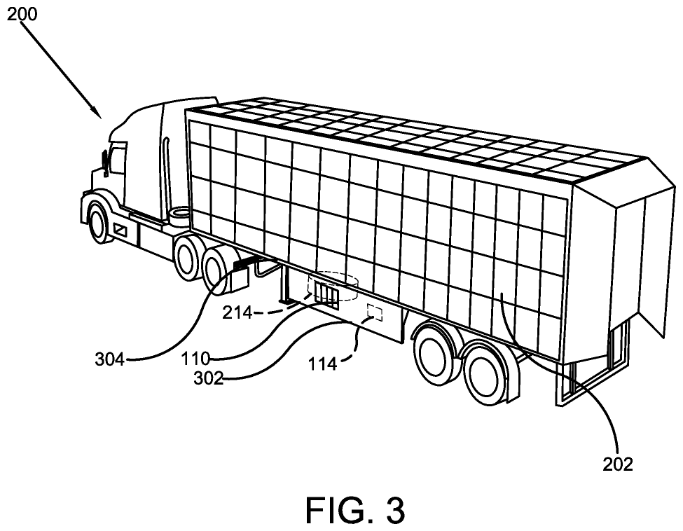

FIG. 3 illustrates a close-up view of the barrier 302 protecting the wind turbine generator 214 and the internal battery pack 114 used in the power generation system 100 of the present invention in accordance with the disclosed specification. The power generation system 100 described in various embodiments of the present invention is installed and fitted in a semi-truck and trailer at the time of manufacturing and offered as part of an OEM package. The system 100 can also be retrofitted to any existing semi-truck if desired by the owner or operator. For protecting the wind turbine generator 214 and the internal battery pack 114 of the system 100, a trailer skirt 302 is mounted along a bottom edge 304 of the trailer 202. The trailer skirt 302 is fixed and does not move easily when the truck 200 is moving on a road. The trailer skirt 302 is made from a heavy metal and is long enough to protect the wind turbine generator 214 and the internal battery pack 114 from physical damage. The trailer skirt 302 can be lifted easily along the bottom edge 304 for accessing the wind turbine generator 214 and the internal battery pack 114. The trailer skirt 302 is further comprised of at least one louver 110, wherein the louver 110 directs wind surrounding the skirt 302

As described above, the louver 110 on the skirt 302 is open when the truck driver releases pressure or is “off the pedal” allowing air to pass through the passage 210 to the trailer mounted wind turbine-generator 214. When the air passes through the turbine-generators 214, the vanes 1060 spin to convert wind energy into electrical energy and the converted electrical energy is supplied to the internal battery 114 of the system. In this manner, a drag force is introduced on the trailer such that the wind turbine-generator 214 functions as an air brake for the truck 200 (i.e., assisting in the braking of the truck 200) while also generating electricity. It should be noted that the louver 110 and generator 214 of the skirt 302 are separate from other generators 104 and louvers 110 for said generators 104 such that the louvers 110 of the generator 214 receives its own air flow from the surrounding area of skirt 302. It should be noted that when all louvers 110, 112 are closed, the truck 200 becomes more aerodynamic than when the drag force is introduced. In one embodiment, the generator 214 is protected by a shroud 306, wherein the shroud 306 is connected to an funnels air from the louvers 110 of the skirt 302 into the generator 214.

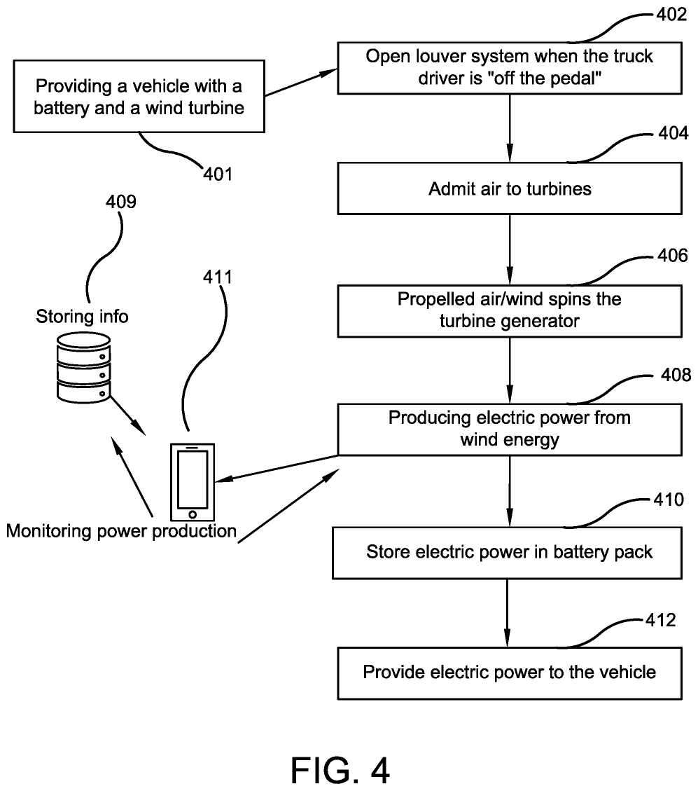

FIG. 4 illustrates a flow diagram showing the process of harnessing wind energy for producing electric power by the semi-truck or other vehicle power generation system of the present invention in accordance with the disclosed specification. At step 401 a vehicle with a battery and a wind turbine mounted on the vehicle is provided. Advantageously, the louver system of the power system 100 is open to admit the incoming air into both the truck mounted and trailer mounted turbines when the truck driver releases pressure on the accelerator pedal is “off the pedal” (Step 402). This creates a drag force on the vehicle that allows the system to function as a braking system for the vehicle. Then, the incoming air from the louver system enters into turbines installed on the semi-truck and trailer to rotate the vanes or blades of the turbines (Step 404). Said air drives the vanes of the turbines to spin the rotor of the generator (Step 406). The system may include a smart device such as a smartphone 411 that is connected to the system. The smart device 411 can be used by the owner operator to monitor the status of the system. The smart device 411 can transmit information to a database 409, which may be at a company headquarters so that the company can monitor the efficiency of each vehicle in the fleet. In addition, the database 409 can be used to transmit information back to the driver if it is determined different operational parameters may be needed to further increase the efficiency of the system.

The wind turbine generator produces electricity from the received wind energy (Step 408) and transfers the electric power to store in the internal battery pack of the power generation system (Step 410). Finally, when the power of the vehicle's battery is low or insufficient, then the electric power stored in the battery pack is provided to the vehicle's battery, thereby allowing the vehicle to continue to operate and run for longer periods on the road without stopping for recharging of the battery (Step 412).

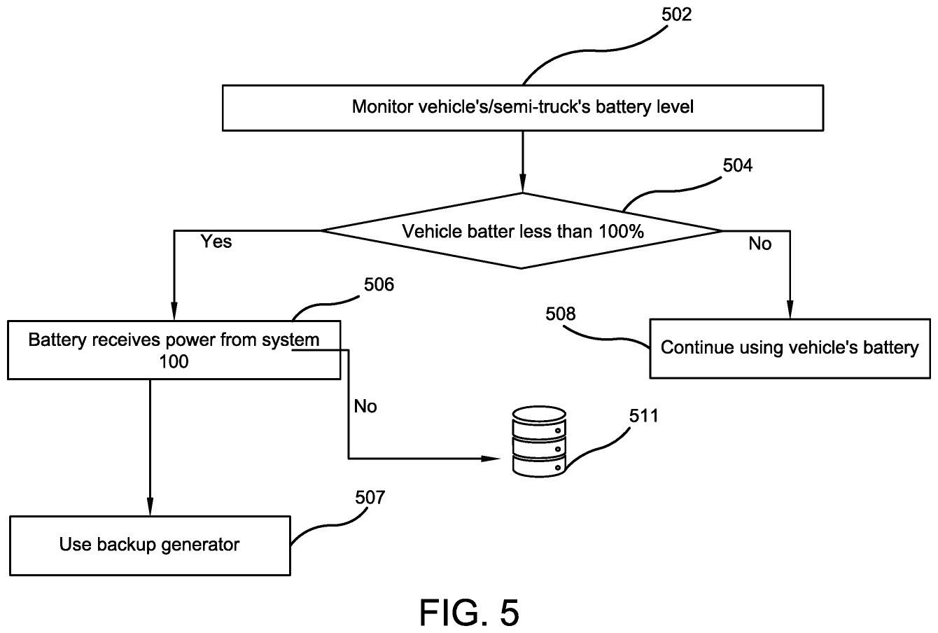

FIG. 5 illustrates a flow diagram showing the steps performed by the renewable power generation system 100 of the present invention for providing electric power to the vehicle's battery and electrical system in accordance with the disclosed specification. One main feature of the system 100 of the present invention is that the system 100 continuously monitors the power level of the vehicle's battery in which the power generator pack 100 is installed (Step 502). If the monitored power level is not at 100% (Step 504), the vehicle battery will receive power from the system 100 via the electric power stored in the internal battery pack of the system 100 (Step 506). If necessary, the 10-50 KVA back up or emergency generator is used for providing power to the vehicle's battery and vehicle's electrical system (Step 507). If the monitored power level is at 100%, the system 100 may not be used (Step 508). A database 511 may be connected to receive information from the system to track system status and to calculate the efficiency of the vehicle and help in maintenance and operation of the vehicle.

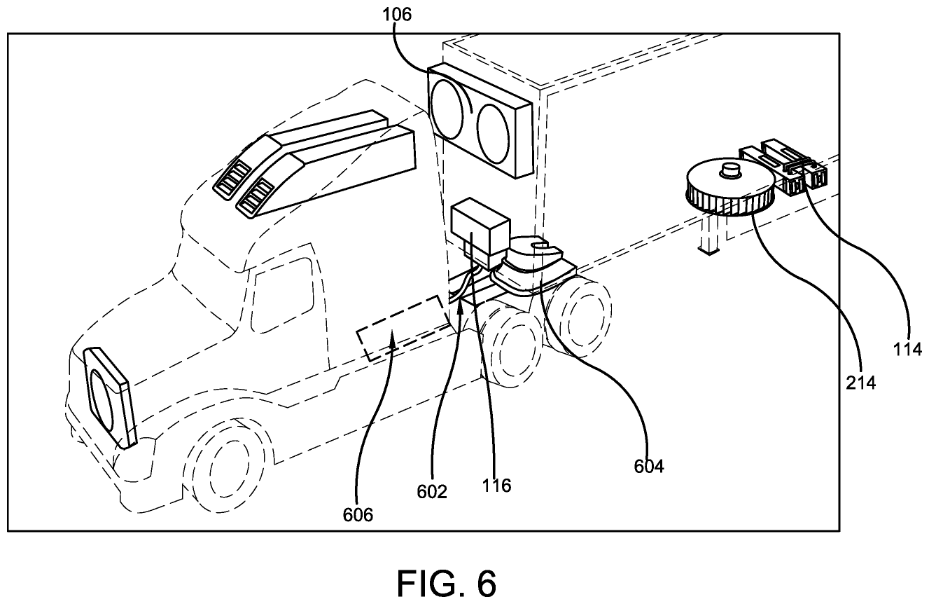

FIG. 6 illustrates a close view showing the connection of the backup generator 116 and electrical battery of the vehicle along with the adaptor or plug for connecting the battery pack of the power generation system 100 of the present invention in accordance with the disclosed system. The backup generator 116 is connected directly to the vehicle's battery 606 through a wired circuit 602 and is used for providing power to the vehicle as described in FIG. 1 and FIG. 5. The backup generator 116 is automatically activated for providing power to the vehicle when both the vehicle's battery 606 and the battery pack 114 are low in power.

The battery pack 114 is connected to the vehicle's battery 606 through the plug adapter 604 that completes an electrical connection between the battery pack 114 and the vehicle's battery 606.

It should be noted that although the vehicle shown in various embodiments is an exemplary semi-truck model, the power system described herein may be used in connection with any other type of vehicles. For example, the system described herein can be used in connection with other automobiles, tractors, boats and/or the like. Such vehicles may be wholly or partially electrically powered.

In some implementations, the turbines (including their blades) may be made out of a carbon fiber type material that may or may not need to be reinforced with Kevlar to aid in the strengthening and efficiency to capture the wind.

It should be appreciated that the aforementioned components of the system 100 do not affect the cargo area of the trailer. The components, as described earlier, are mounted outside of the trailer. The wiring system connecting the components may be adaptable to function with different shapes and sizes of vehicles. For example, the wiring may be incorporated throughout the length of the vehicle, the body of the vehicle, underneath the vehicle and/or in any way to provide power to the vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “power generation system”, “renewable power generation system”, “power system”, “system”, and “power generator pack” are interchangeable and refer to the renewable and environment friendly power generation system 100 of the present invention.

Notwithstanding the forgoing, the renewable and environment friendly power generation system 100 of the present invention can be of any suitable size and configuration as is known in the art without affecting the overall concept of the invention, provided that it accomplishes the above-stated objectives. One of ordinary skill in the art will appreciate that the size, configuration and material of the renewable and environment friendly power generation system 100 as shown in the FIGS. are for illustrative purposes only, and that many other sizes and shapes of the renewable and environment friendly power generation system 100 are well within the scope of the present disclosure. Although the dimensions of the renewable and environment friendly power generation system 100 are important design parameters for user convenience, the renewable and environment friendly power generation system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for generating electric power for a motor vehicle, the system comprising the steps of:
a vehicle having a battery for providing a motive force to drive the vehicle;
at least one system for collecting an energy from a renewable source, wherein the at least one system is connected to the battery for charging the battery to maintain an energy level within the battery; and
an emergency generator provided on the vehicle for providing a generated energy to the battery.

2. The system as recited in claim 1, wherein the at least one system for collecting energy from a renewable source is one of a wind turbine and a plurality of solar panels.

3. The system as recited in claim 1, wherein at least two distinct systems are provided for charging the battery.

4. The system as recited in claim 3, wherein the at least two distinct systems are a wind turbine and a plurality of solar panels.

5. The system as recited in claim 1 further comprising a database connected to each of the battery and the at least one system for determining an efficiency of the system.

6. The system as recited in claim 5, wherein the emergency generator is operated when the energy level in the battery is not at 100 percent.

7. The system as recited in claim 2, wherein the wind turbine is connected to a louver to allow incoming air to enter the wind turbine.

8. The system as recited in claim 4, wherein each of the wind turbine and the plurality of solar panels are mounted on an exterior surface of the vehicle.

9. The system as recited in claim 4, wherein the wind turbine is disposed on a front area of a trailer connected to the vehicle and the plurality of solar panels are mounted on a top surface of the trailer of the vehicle.

10. A renewable energy charging source comprising:
an electric vehicle having a battery;
a wind turbine in electrical communication with the battery; and
a solar panel in electrical communication with the battery, wherein the battery receives an energy from at least one of the wind turbine and the solar panel for maintaining a charge in the battery that is sufficient to drive the electric vehicle.

11. The renewable energy charging source as recited in claim 10 further comprising an emergency generator connected to the battery.

12. The renewable energy charging source as recited in claim 10, wherein the emergency generator supplies energy to the battery.

13. The renewable energy charging source as recited in claim 10 further comprising a smart device connected to the battery for monitoring a status of the battery.

14. The renewable energy charging source as recited in claim 13, wherein the smart device is connected to a database for recording an information relating to an operation of the electric vehicle.

15. The renewable energy charging source as recited in claim 10, wherein each of the solar panel and wind turbine are mounted on the electric vehicle.

16. A method of using a renewable energy charging system for an electric battery, the method comprising the steps of:
providing a vehicle having an electric battery and a wind turbine mounted to the vehicle;
opening a louver system connected to the wind turbine to allow a flow of incoming air to enter the wind turbine;
using the flow of incoming air to propel the wind turbine;
producing an electric power from the propelling of the wind turbine;
storing the electric power in a battery pack; and
providing the electric power from the battery pack to the vehicle.

17. The method of using a renewable energy charging system as recited in claim 16 further comprising the step of including a smart device to monitor the step of producing electric power.

18. The method of using a renewable energy charging system as recited in claim 17 further comprising the step of storing information relating to the step of producing electric power in a database connected to the smart device.
